(19) United States
(12) Patent Application Publication
(10) Pub. No.: US 2017/0266826 A1
(43) Pub. Date: Sep. 21, 2017

(54) Razor Assembly

(71) Applicants: Ryan Kole, Glencoe, IL (US); Matthew Spenko, Chicago, IL (US); Naftali Garber, Chicago, IL (US)

(72) Inventors: Ryan Kole, Glencoe, IL (US); Matthew Spenko, Chicago, IL (US); Naftali Garber, Chicago, IL (US)

(21) Appl. No.: 15/098,349

(22) Filed: Apr. 14, 2016

Related U.S. Application Data
(60) Provisional application No. 62/148,165, filed on Apr. 15, 2015.

(51) Int. Cl. B26B 21/40; B26B 21/42; B26B 21/34; B26B 21/22; B26B 21/02

(52) U.S. Cl. CPC B26B 21/4062; B26B 21/227; B26B 21/02; B26B 21/34; B26B 21/4018; B26B 21/42

(57) ABSTRACT

One or more implementation disclosed herein provides razor assemblies that allow a user to have a less than smooth shave by changing the distance between razor blades and a razor blade guard. The distance between the razor blade(s) and the guard may be increased or decreased using a movable knob mechanism, a rotatable dial mechanism, a movable razor assembly and housing mechanism, a rotatable threaded handle, one or more slider mechanisms, a rotating blade mechanism, etc.

### REFERENCE INFORMATION

This application is based on and takes priority from the provisional patent application entitled “A Safety Razor (or Manual Shaving Razor) Which Allows a User to Shave with The Intention of Leaving Some Hair Remaining On the Part(s) Shaved,” filed on Apr. 15, 2015, with Ser. No. 62/148,165, which and incorporated herein in its entirety by reference.

### BACKGROUND

Conventionally, razors and razor assemblies, whether manual or electric are typically designed to provide a sharp clean look. For example, most of the razor advertising emphasize the smooth shave look after shaving. However, current changing trend amongst males is for keeping some facial hair. The workplace has gone from being a place requiring a cleanly shaven face to accepting some stubble, a 5 o'clock shadow or a beard.

### SUMMARY

One or more implementation disclosed herein provides razor assemblies that allow a user to have a less than smooth shave by changing the distance between razor blades and a razor blade guard. The distance between the razor blade(s) and the guard may be increased or decreased using a movable knob mechanism, a rotatable dial mechanism, a movable razor assembly and housing mechanism, a rotatable threaded handle, one or more slider mechanisms, a rotating blade mechanism, etc.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. These and various other features and advantages will be apparent from a reading of the following detailed description.

### BRIEF DESCRIPTIONS OF THE DRAWINGS

The described technology is best understood from the following Detailed Description describing various implementations read in connection with the accompanying drawings.

FIG. 1 illustrates a three-dimensional view of an example razor assembly that allows adjustable shaving depth.

FIG. 2 illustrates three-dimensional views of example razor heads that allows adjustable shaving depth.

FIG. 3 illustrates an alternative three-dimensional view of another example razor head that allows adjustable shaving depth.

FIG. 4 illustrates a three-dimensional view of another example razor assembly.

FIG. 5 illustrates a three-dimensional view of an example razor head mechanism including rotating blades which are rotated when the wheels on the sides are moved.

FIG. 6 illustrates a three-dimensional view of an alternative example razor assembly that allows adjustable shaving depth.

FIG. 7 illustrates three-dimensional views of alternative example razor heads that allows adjustable shaving depth.

FIG. 8 illustrates three-dimensional views of an example three blade razor with top and side guards added for depth.

FIG. 9 illustrates (a) a three blade razor with plastic guard over top of razor blade only, which is thinner than other versions allowing for less hair remaining after a shave and (b) two blade razor with plastic guard over top of razor blade only, which is thinner than other versions allowing for less hair remaining after a shave.

FIG. 10 illustrates (a) Two blade razor with plastic guard over top and side of razor blade, which is thicker than other versions allowing for more hair remaining after a shave and (b) three blade razor with plastic guard over top and sides of razor blade, which is thicker than other versions allowing for more hair remaining after a shave.

FIG. 11 illustrates (a) two blade razor with plastic guard over top of razor blade only, which is thicker than other versions allowing for more hair remaining after a shave and (b) a razor assembly prototype without razor blade and guard being shown.

FIG. 12 illustrates various sized razor blade holders or guards of differing thickness and shape.

FIG. 13 illustrates various sketches illustrating framing a razor guard in various ways in stationary settings.

### DETAILED DESCRIPTION

One or more implementations of a manual razor disclosed herein allow a user to shave with the intention of leaving some hair remaining on the part(s) shaved. The razor handle and/or razor blade itself can be designed to allow for space between the area of the body shaved and the razor blade, which would prevent a “clean” (removal of as much as the hair as possible) shave. While the various implementations disclosed here are discussed in view of shaving a user's face, they can also be used to shave other parts of the body, including but not limited to the head, genital areas, back, armpits, chest, and back.

Specifically, one or more implementations of the technology disclosed herein allows for a manual razor to allow a male to shave with a manual razor with the intention of keeping his facial hair to a predetermined length rather than completely removing all of it as all current manual razors offer. This can be done through a razor blade that is set back far enough from the user's face, to prevent a removal of all the hair. There are other ways besides setting the blade back. One such way is to put a razor cover on top of a current blade. The disclosed implementations allow for a replaceable or non-replaceable razor blade cartridge that is configured to allow for a shave that purposely leaves hair remaining. The depth of the razor blade can be altered providing for various lengths of hair remaining. In fact, one razor blade cartridge can be constructed so that it can be moved forward or back, thereby decreasing or increasing respectively the distance between the user's face and blade, allowing for a completely clean shave or shave that keeps a beard remaining, acting similar to a beard trimmer. The shaver can choose the amount of hair he wants to remain after a shaving by adjusting the dial for example of choosing the non-adjustable guard that is set at specified distance from the razor blade.

The design shown in the picture has a piece of plastic, also called a guard (the present invention is not limited to plastic as any material can possibly be used) that provides the distance needed between the razor blade and the user's body, i.e., his face. The thickness of this plastic can be altered allowing for more or less hair to be shaven off. The shape of the plastic can just be around the top part of the blade, around the top and sides and/or around the whole blade. If the razor blade could be adjusted, this would be done through moving some part of the razor blade cartridge manually or some part of the razor blade handle (the part held by the user when shaving, that holds the razor blade cartridge.

The design of the present invention allows for use on 1, 2, 3, 4, 5, 6, 7 or more blades. The level of hair remaining can be greater than 0 mm by using this design. The pictures below show designs that allow for hair growth of 0.5 mm to 1 mm remaining. The disclosed implementations include all lengths of hair growth remaining, not being limited to the designs shown in the pictures. The present invention is not limited to replaceable razors. It could be used with disposable (meant for a 1 time use) razors. Another option to create the desired effect is to have a razor blade that is dull, preventing it from removing all the hair.

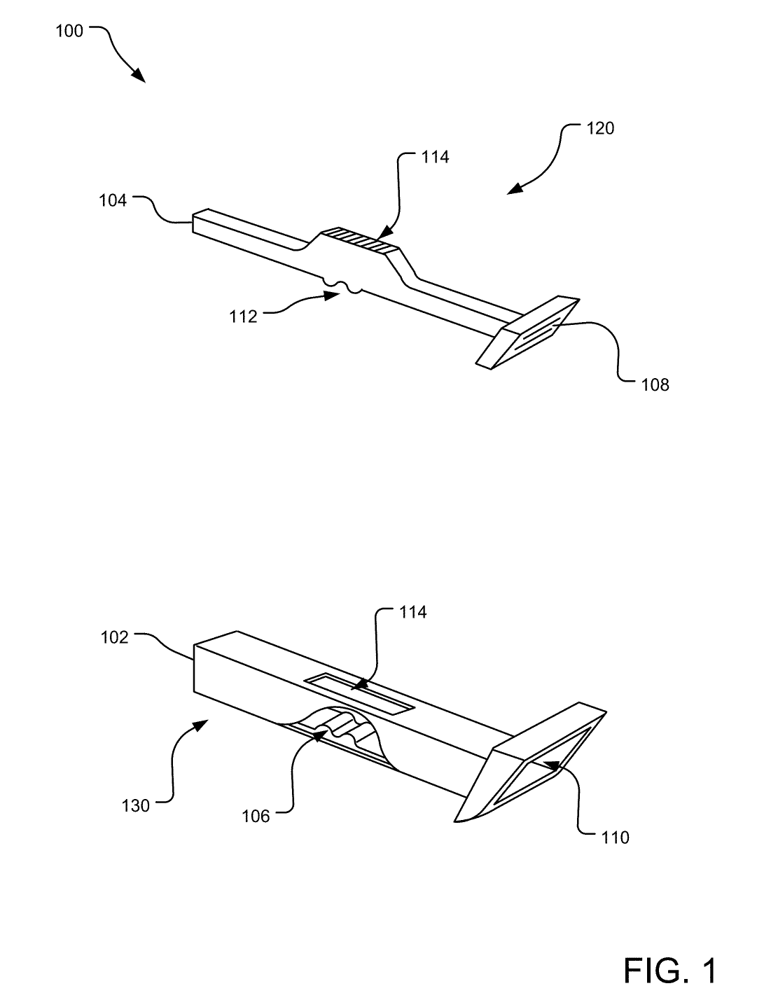

FIG. 1 illustrates a three-dimensional view of an example razor system 100 that allows adjustable shaving depth. Specifically, the razor system 100 includes a razor assembly 120 including a razor handle 104 attached to a razor blade 108, the razor handle having a first outer surface with a slider mechanism 112 and a second outer surface including a knob 114, the second outer surface being on the opposite side of the first outer surface.

A hollow razor housing 130 is configured to house the razor assembly 120, the razor housing including a groove 106 on one internal surface configured to be in proximity to the slider mechanism 112 of the razor assembly 120 such that the razor assembly 120 can be slidably moved along length of the razor housing 130 (or vice versa, 130 slidably moved along assembly 120) to change the distance between the razor blade 108 and an outer face opening 110 of the razor housing 130. The razor housing further includes an opening 114 on an outer surface to allow the knob 114 to protrude from the razor housing 130.

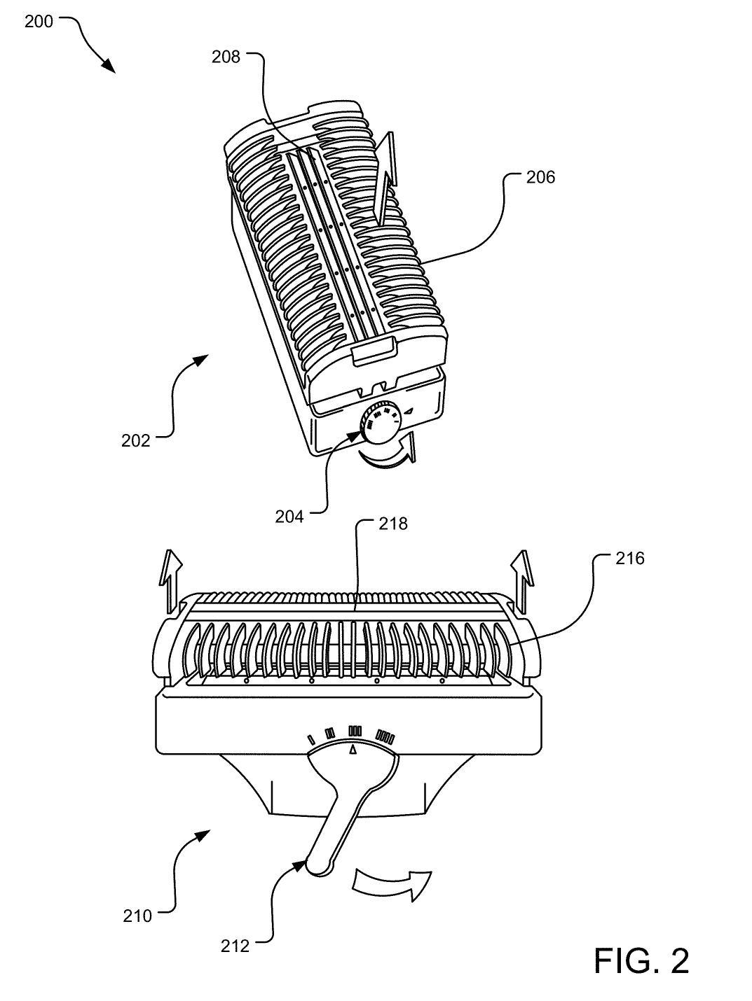

FIG. 2 illustrates three-dimensional views of example razor heads 200 that allows adjustable shaving depth. Specifically, a razor head 202 provides for a dial 204 that can be used to adjust space between blades 208 and guard 206. For example, a user can turn the dial 204 to increase or decrease the vertical space between the blades 208 and the top surface of the guard 206. The top surface of the guard 206 comes in face with a user using the razor head 202. Thus, if the vertical space between the blades 208 and the top surface of the guard 206 is lower, it results in smoother shave. The higher this space, the rougher is the resulting shave (more hair remaining).

An alternative implementation of a razor head 210 provides a knob 212 that can be used to adjust the space between blades (not shown) and guard 216. For example, a user can turn the knob 212 to increase or decrease the vertical space between the blades and a top surface 218 of the guard 216. The top surface 218 of the guard 216 comes in face with a user using the razor head 210. Thus, if the vertical space between the blades and the top surface 218 of the guard 216 is lower, it results in smoother shave. The higher this space, the rougher is the resulting shave (more hair remaining).

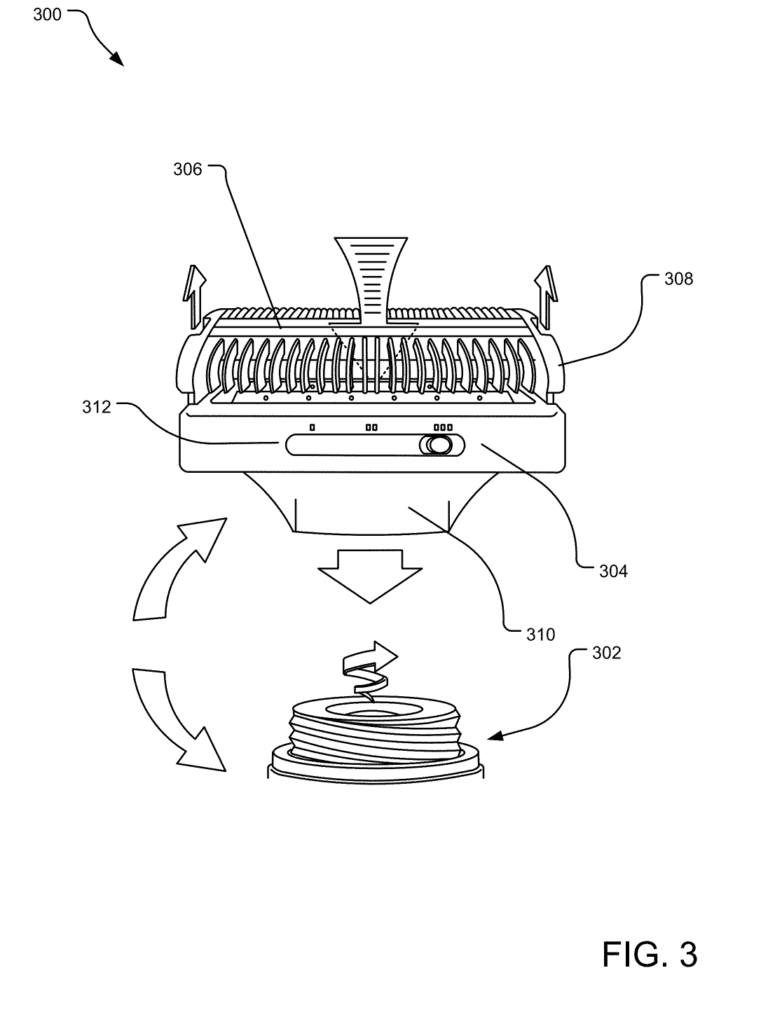

FIG. 3 illustrates an alternative three-dimensional view of another example razor head 300 that allows adjustable shaving depth. Specifically, the razor head 300 is shown with a threaded end 302 of a razor handle and a razor head 304 including a receiving end 310 configured to receive the threaded end 302. The threaded end 302 can be rotated to adjust the position of a guard 308 with respect to blades (not shown). Specifically, the threaded end 302 can be rotated in or out of the receiving end 310 so that a vertical distance between the blades and a top surface 306 of the guard 308 changes. Such distance can be shown by a display 312, so that a user can see how closer or rougher shave will result with the given position of the guard 308 with respect to the blades.

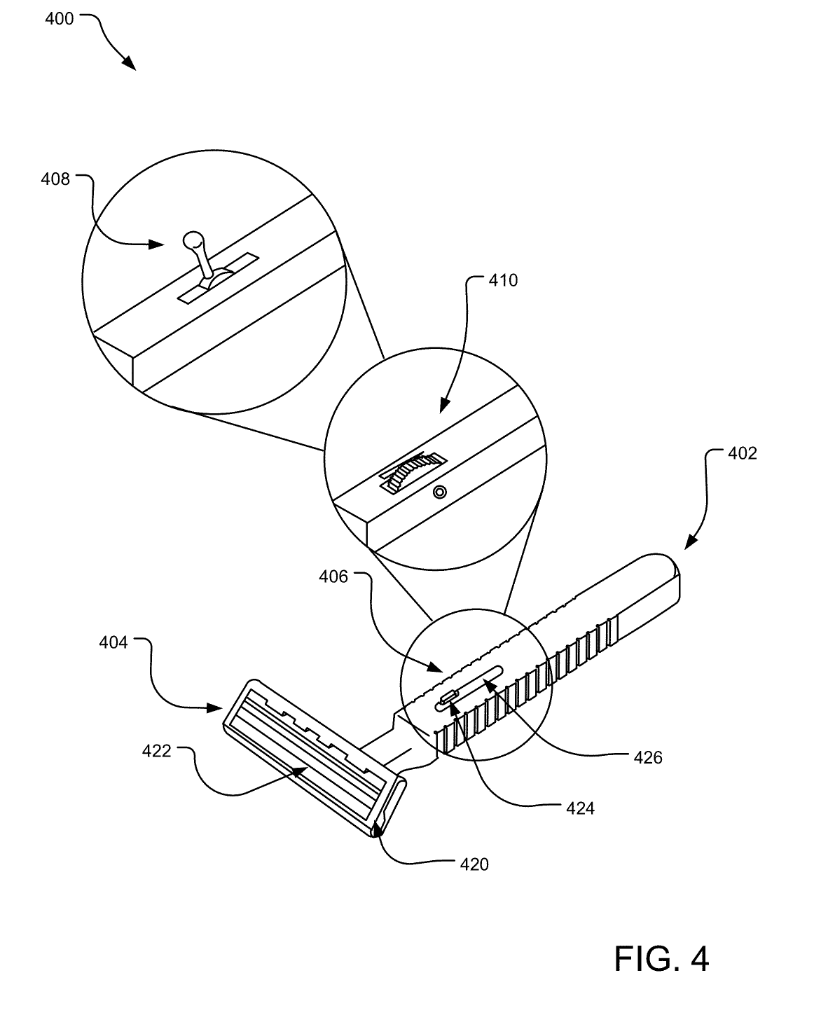

FIG. 4 illustrates a three-dimensional view of another example razor assembly 400. The razor assembly includes a razor handle 402 and a razor head 404 including a guard 420 and blades 422. An adjustment mechanism 406 located on and inside the razor handle 402 can be used to adjust the distance between the blades 422 and the guard 420. In one implementation, such adjustment mechanism 406 is a sliding knob 424 that slides in a groove 416 along the length of the handle. The sliding knob 424 may be connected via a sliding structure (not shown) inside the handle and attached to the blades 422 so that the distance between the blades 422 and the face of the guard 420 can be adjusted to provide shaving to the user with different levels (smooth, stubble, 5 o'clock shadow, beard, etc.). In alternative implementations, a sliding wheel 410 or a sliding handle 408 may be used to control the position of the blades 422 with respect to the front face of the guard 420.

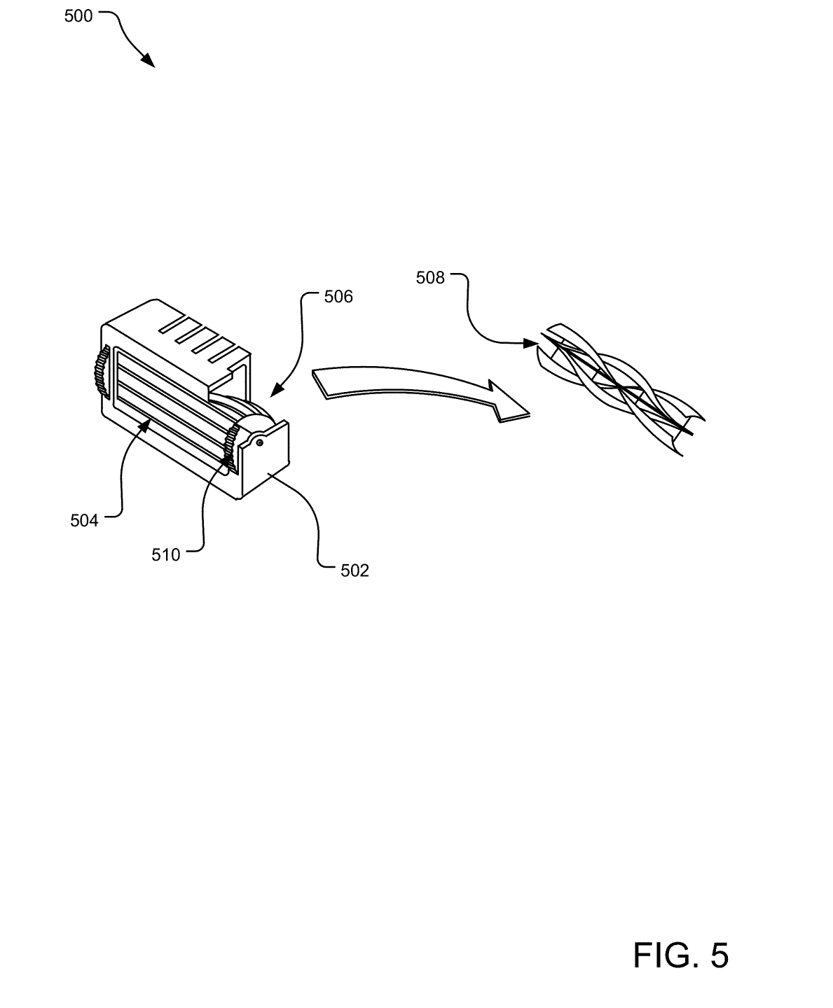

FIG. 5 illustrates a three-dimensional view of an example razor head mechanism 500 including rotating blades 506 (which are also shown separately as 508). The rotating blades 506 are attached to spinning wheels 510. The spinning wheels 510, when moved by sliding on face or body part of a user, cause the rotating blade 506 to spin and cause shave. The rotating blades are located in a guard 502 having a guard face 504 having slotted openings. One or more of the mechanisms for moving a guard in comparison to blades can be used to adjust the distance between the rotating blades 506 and the guard face 504 so as to change the level of shaving provided to the user. The spinning wheels 510 may be configured to move away from the guard face 504 to increase the distance between the rotating blades 506 and the guard face 504.

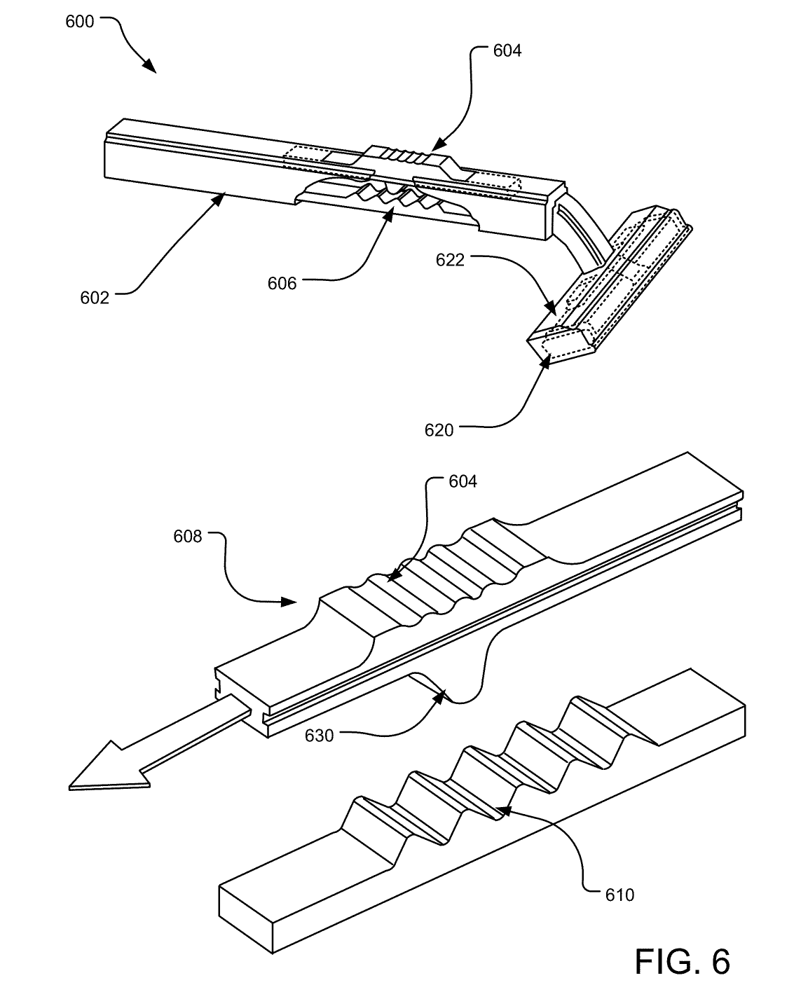

FIG. 6 illustrates a three-dimensional view of an alternative example razor assembly 600 that allows adjustable shaving depth. Specifically, the razor assembly 600 is illustrated to include a partially hollow housing 602 within which a razor arm and blade assembly can move. The razor arm and blade assembly may include a head 620 (shown with dotted lines) with blades (not shown) that move with respect to the guard 622, which is attached to the hollow housing 602.

A slider knob 604 that is attached to the razor arm and blade assembly can be used by a user to change the distance or space between the guard 622 and the blades. The razor arm also has a slider 630 that slides along grooves 610 along a lower inner surface of the housing 602 to provide variable positions for razor arm within the housing and thus variable distances between the blades and the guard 622.

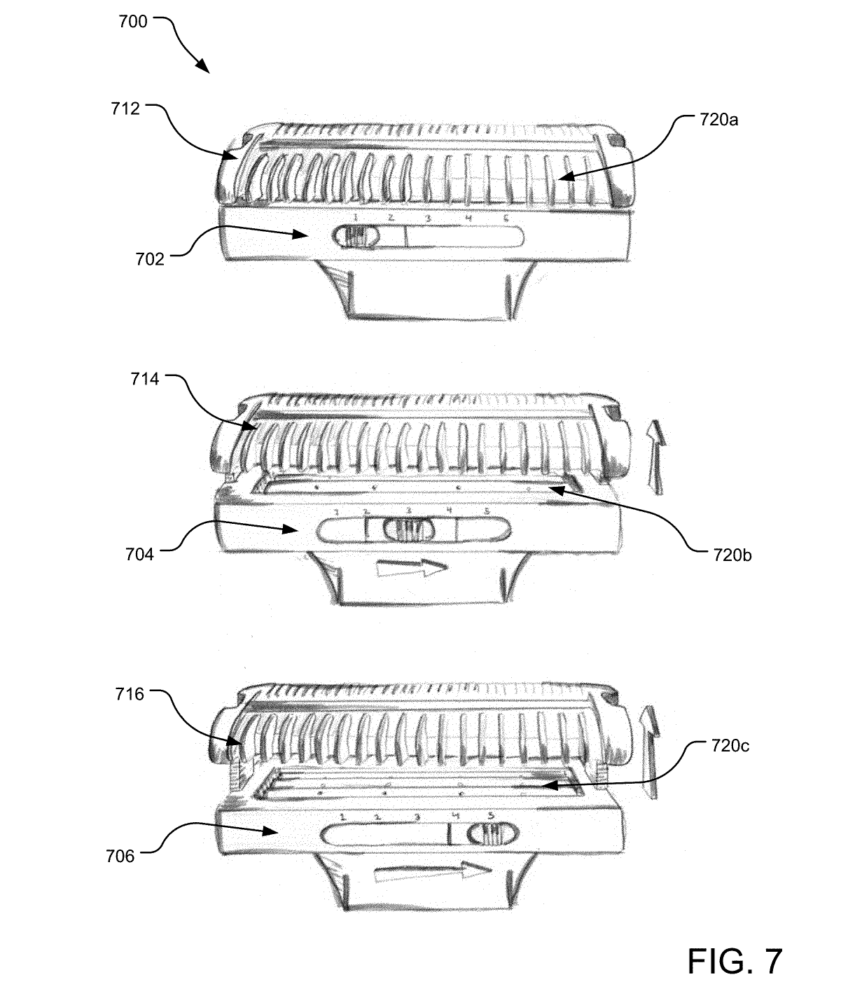

FIG. 7 illustrates three-dimensional views of alternative example razor heads 700 that allows adjustable shaving depth. Specifically, the razor heads 700 are illustrated with a position of a knob at three different locations and based on the position of the knob, changing a space or distance between guard and blades. Specifically, at the knob position 702 the guard 712 is positioned such that the blade 720a is very close to the guard. In this implementation, the user gets a considerably close shave. At the knob position 704, the guard 714 is shown to have moved up—away from the blade 720b, resulting in increased space between the blade 720b and the guard 714, which results in a rougher shave for a user (a minimal amount of hair remains). Finally, at the know position 706, the guard 716 is shown to have moved further up—substantially away from the blade 720c, resulting in substantially increased space between the blade 720c and the guard 716, which results in a considerably rougher shave for a user (even a greater amount of hair remains). Note that the knob can be moved to a higher or lesser number of positions to finely adjust the difference in shave length/stubble for the user. Furthermore, instead of having numbers providing distinct positions along the length, the know may also be moved along in an analog manner.

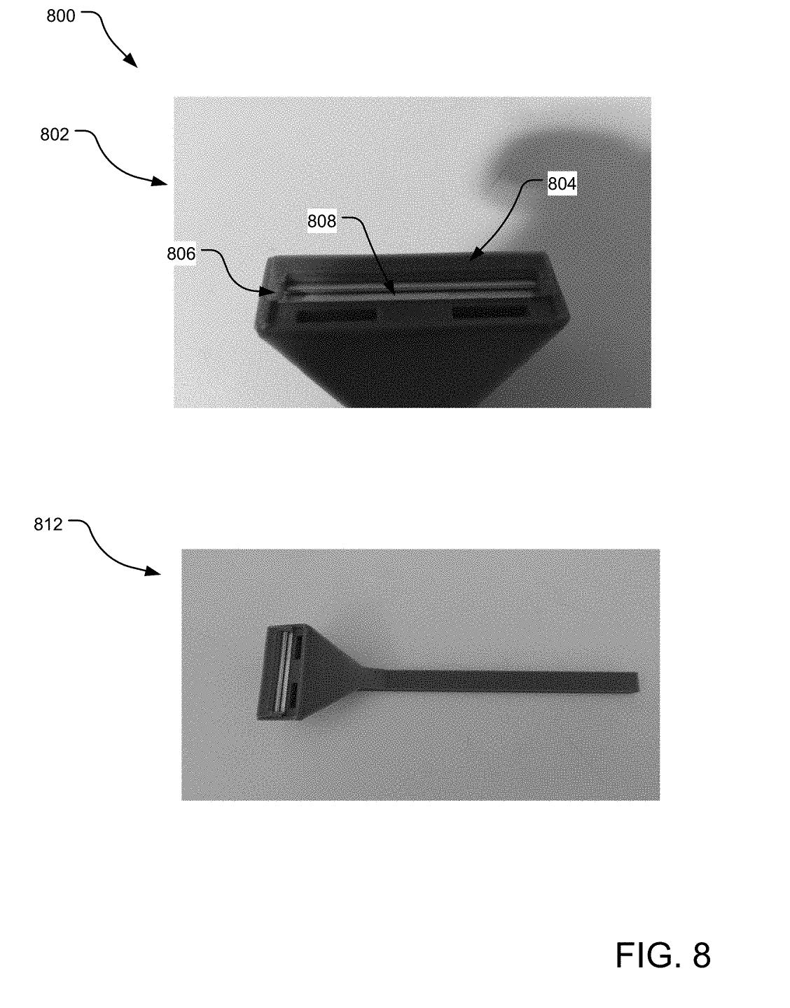

FIG. 8 illustrates three-dimensional views 800 of an example three blade razor with top 804 and side guards 806 added for depth between the guards 804 and 806 and blades 808. The view 812 illustrates an implementation with a handle.

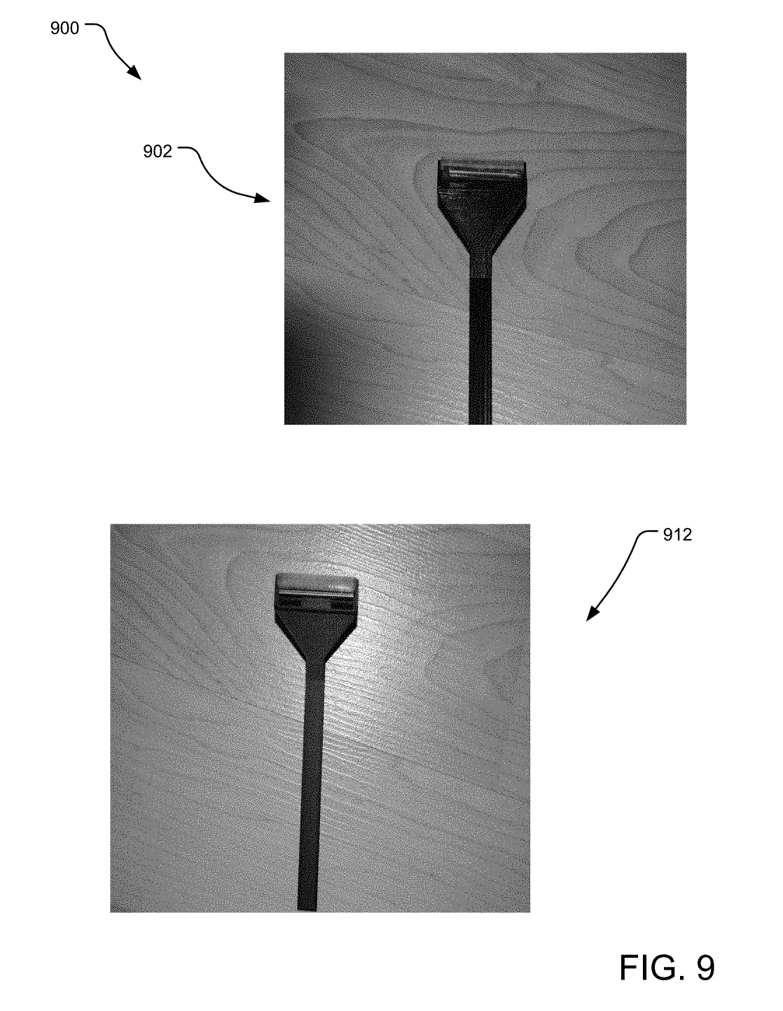

FIG. 9 illustrates (a) a three blade razor 902 with plastic guard over top of razor blade only, which is thinner than other versions allowing for less hair remaining after a shave and (b) two blade razor 912 with plastic guard over top of razor blade only, which is thinner than other versions allowing for less hair remaining after a shave.

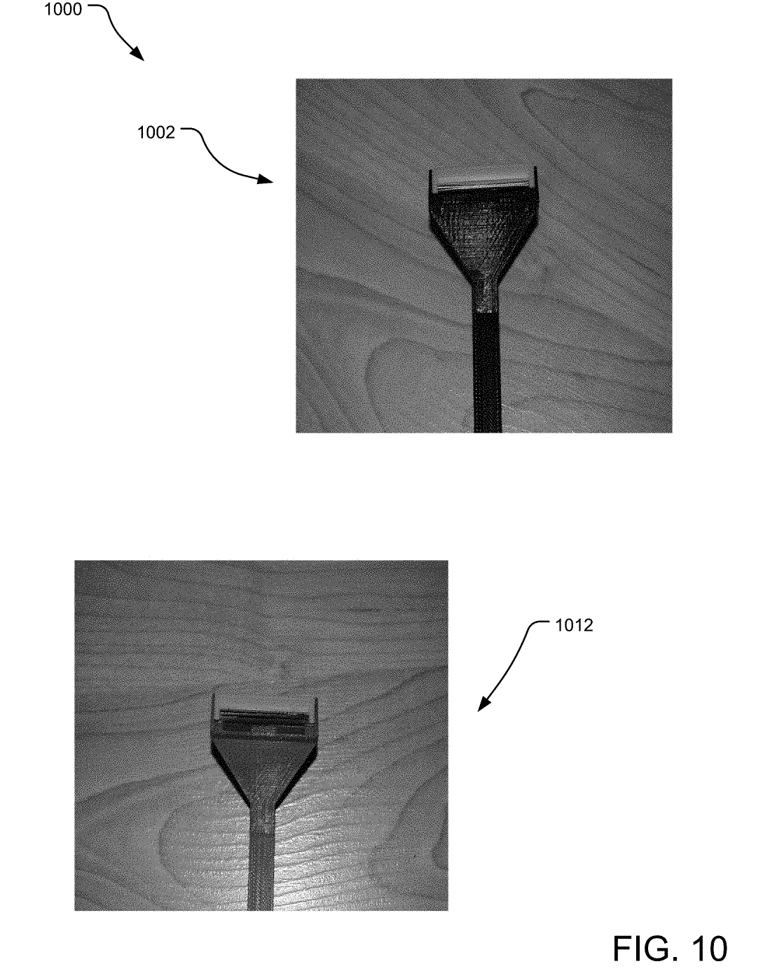

FIG. 10 illustrates (a) Two blade razor 1002 with plastic guard over top and side of razor blade, which is thicker than other versions allowing for more hair remaining after a shave and (b) three blade razor 1012 with plastic guard over top and sides of razor blade, which is thicker than other versions allowing for more hair remaining after a shave.

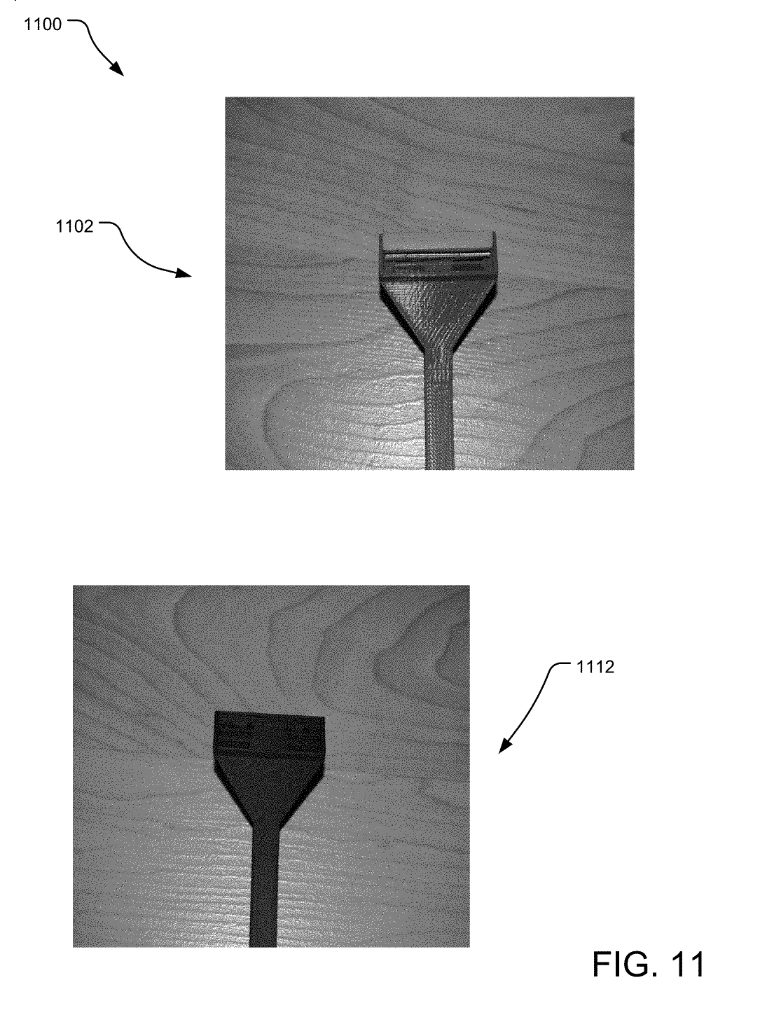

FIG. 11 illustrates (a) two blade razor 1102 with plastic guard over top of razor blade only, which is thicker than other versions allowing for more hair remaining after a shave and (b) a razor assembly prototype 1112 without razor blade and guard being shown.

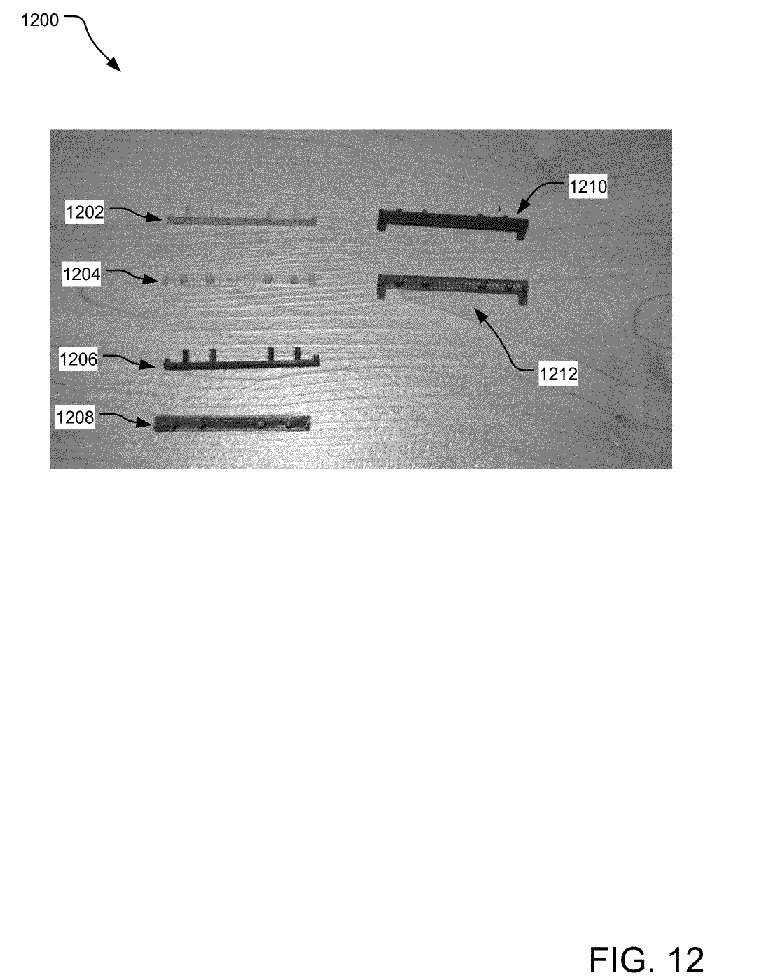

FIG. 12 illustrates various sized razor blade holders 1200 of differing thickness and shape. Specifically, FIG. 12 illustrates a razor blade holder 1202 that provides a guard for either the top or bottom only, with pegs that fit through the holes in the razor blade(s) and handle and pegs on the side that attach to the side of the razor cartridge. A razor blade holder 1204 that provides a guard for either the top or bottom of the razor blade with a thickness thinner than 1202. FIGS. 1202 and 1204 can be combined with one being used for the top guard and the other for the bottom guard. A razor blade holder 1206 that provides a guard similar to 1202 and 1204 but with a thickness greater than 1202. A razor blade holder 1208 that is wider than 1202, 1204 and 1206 that can act as a razor guard. A razor blade holder 1210 that provides a guard for either the top and two sides or the bottom and two sides, with pegs that fit through the holes in the razor blade(s) and secure into the handle. A razor blade holder 1212 that is similar to 1210 but thinner allowing for a closer shave.

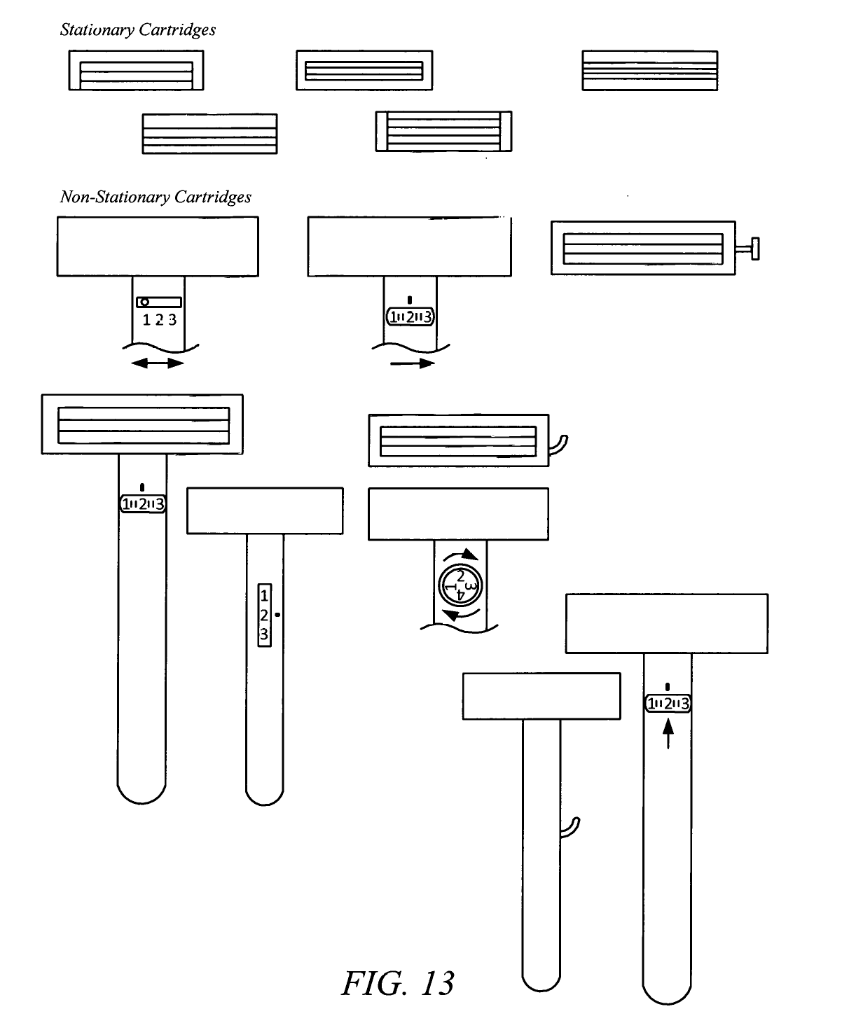

FIG. 13 illustrates various sketches 1300 illustrating framing a razor guard in various ways in stationary settings. For a stationary cartridge, the raised guard may be, although it doesn't have to be, permanent in its position. In other words, in one implementation, if the guard is raised by 0.5 mm, it is always raised by 0.5 mm. In an alternative implementation the razor cartridge could have a guard raised by another amount of distance, such as for example, 1 mm, 1.5 mm, etc. Here, the “raised guard” may refer to size of a spacer that separates the blade from the face of a user.

Specifically, the sketches 1-5 illustrate fixed guards:

#1. The raised guard is on 3 sides (not the bottom)

#2. The raised guard is on the top, above the blades only

#3. The raised guard is on all 4 sides, surrounding the blades.

#4. The raised guard is only on the sides.

#5. The raised guards are on the top and bottom only, although in an alternative implementation, the guard can be on the bottom only.

The following sketches 6-8 disclose adjustable guards raise:

#6. On the back of the cartridge, a knob can be pushed left or right to increase or decrease the distance of the blades to the face

#7. Same as #6 but with a dial

#8. same as #6 but twist a device to make guard move back and forth

The following sketches 9-14 illustrate razors where depth of the guard/spacer are controlled from a handle:

#9. A dial is used on the handle to control the depth of the guard/spacer.

#10. On the back of the handle, the depth can be controlled

#11. A lever can be lifted up or pushed down to move the guard/spacer

#12. On the back, a dial which shows how many days of hair growth you'd like to keep, i.e., 1 day, 3 days, 5 days.

#13. A lever is on the side of the handle, sticking out, allowing adjustment of the guard/spacer.

#14. A user can push a pin (for lack of better words) right and left going through the handle, that allows the guard/spacer to be adjusted.

Alternatively, razor assemblies may be provided where one or two blades whose sole purpose is to lift the hair while a following blade trims it. Furthermore, each of the razor assemblies disclosed herein where the space or distance between the blades and face is controlled by moving the guard/spacer, similar space or distance may also be achieved by keeping the guard/spacer stationary, but moving the blades away from the front end (that comes in touch with user's face/beard) of the guard so as to alter the distance between the blade and front end (that comes in touch with user's face/beard) of the guard.

The above specification and examples provide a complete description of the structures of exemplary implementations of apparatus that may be used for waveform based bit detection for bit patterned media. Although various implementations of the apparatus have been described above with a certain degree of particularity, or with reference to one or more individual implementations, those skilled in the art could make numerous alterations to the disclosed implementations without departing from the spirit or scope of the presently disclosed technology. It is intended that all matter contained in the above description and shown in the accompanying drawings shall be interpreted as illustrative only of particular implementations and not limiting. The implementations described above and other implementations are within the scope of the following claims.

What is claimed:

1. A razor system, comprising:
a razor assembly including a razor handle attached to a razor blade, the razor handle having a first outer surface with a slider mechanism and a second outer surface including a knob, the second outer surface being on the opposite side of the first outer surface; and
a hollow razor housing configured to house the razor assembly, the razor housing including a groove on one internal surface configured to be in proximity to the slider mechanism of the razor assembly such that the razor assembly can be slidably moved along length of the razor housing to change the distance between the razor blade and an outer face opening of the razor housing.

2. The razor system of claim 1, wherein the razor housing further comprising an opening on an outer surface to allow the knob to protrude from the razor housing.

3. A razor system, comprising:
a razor head including razor blades, a razor guard, and an adjusting mechanism configured to control the distance between a face of the razor guard and the blades; and
a razor handle attached to the razor head.

4. The razor system of claim 3, wherein the adjusting mechanism including a knob to control the distance between a face of the razor guard and the blades by moving the razor blades away from the face of the razor guard.

5. The razor system of claim 3, wherein the adjusting mechanism including a knob to control the distance between a face of the razor guard and the blades by moving the face of the razor guard away from the razor blades.

6. The razor system of claim 3, wherein the adjusting mechanism including a dial to control the distance between a face of the razor guard and the blades by moving the razor blades away from the face of the razor guard.

7. The razor system of claim 3, wherein the adjusting mechanism including a dial to control the distance between a face of the razor guard and the blades by moving the face of the razor guard away from the razor blades.

8. The razor system of claim 3, wherein the razor blades being in the form of rotating razor blades.

9. The razor system of claim 8, wherein the rotating razor blades being attached to spinning wheels configured to slide on a bodily surface of a user.

10. The razor system of claim 9, wherein the spinning wheels being configured to move the rotating razor blades away from the face of the razor guard.
